(19) United States
(12) Patent Application Publication
(10) Pub. No.: US 2008/0258518 A1
(43) Pub. Date: Oct. 23, 2008

(54) COLLISION SAFETY DEVICE BEING APPLICABLE TO INFANT SEATS

(75) Inventor: Manuel JANE SANTAMARIA, Palau Solita I Plegamans (ES)

Correspondence Address: MERCHANT & GOULD PC, P.O. BOX 2903, MINNEAPOLIS, MN, 55402-0903, US

(73) Assignee: Jane, S.A., Palau Solita I Plegamans (ES)

(21) Appl. No.: 12/050,641

(22) Filed: Mar. 18, 2008

(30) Foreign Application Priority Data
Apr. 23, 2007 (ES) 200700827 U

(51) Int. Cl. B60N 2/42

(52) U.S. Cl. 297/216.11

(57) ABSTRACT

A safety device is characterized is made by a chamber (1) of flexible walls filled with air and a nipple (5) to facilitate the progressive outflow of the air when the chamber (1) is highly pressed. The nipple (5) has a valve (6) to prevent the accidental outflow under low pressures of the air occupying the chamber (1) and to give way when receiving a high pressure thereby facilitating the outflow of the air. The chamber (1) is preferentially subdivided into several departments (2, 3 and 4) each of them having a nipple (5) for the outflow of the air. The chamber (1) and the valve (6) are arranged in the inside of the complementary side members (7) of the backrest (8) of the infant seat and in the complementary side members (9) of the headrest (10) of the backrest.

### OBJECT OF THE INVENTION

Collision safety device being applicable to infant seats.

### BACKGROUND OF THE INVENTION

There exist several types of seats being designed for children and for their safety being generally installed on the back seats of motorcars, said seats comprising a backrest being provided with a headrest, said backrest and headrest each having respective complementary side members.

Patent EP-0931694 relates to an infant seat being applicable to motorcars and comprising at each of the sides of the backrest a respective protection for the child's head, said protections being each made up by a flexible air chamber being such as to bring about an outflow of the air in case of a collision.

### SUMMARY OF THE INVENTION

This invention has as its object a safety device being applicable to this type of seats and such as to protect the child, i.e. mainly its head and sides, in case of a collision.

This device is made up by a chamber of flexible walls being filled with air and comprising a nipple being such as to facilitate the progressive outflow of the air when the chamber is highly pressed, the nipple having valve means being such as to prevent the accidental outflow under low pressures of the air occupying the chamber and to give way when this latter is subjected to a high pressure thereby facilitating the progressive outflow of the air.

The chamber will be preferentially subdivided into several departments so as to be in a position to control different pressures depending on the force of the collision, and it will be arranged in the inside of the complementary side members of the backrest of the infant seat and of those of the headrest of said backrest.

These and other characterizing features will be best made apparent by the following detailed description whose understanding will be made easier by the accompanying sheet of drawings showing a practical embodiment being cited only by way of example not limiting the scope of the present invention.

### DESCRIPTION OF THE DRAWINGS

In the drawings:

FIG. 1 illustrates in a perspective view the chamber making up the device being the object of the invention;

FIG. 2 shows in an elevational view the arrangement of said chamber in one of the complementary side members of the headrest of the backrest;

FIG. 3 shows in a diagrammatic longitudinal section one example of the valve means acting on the nipple of the chamber; and

FIG. 4 depicts in a front elevation a backrest being provided with the safety device.

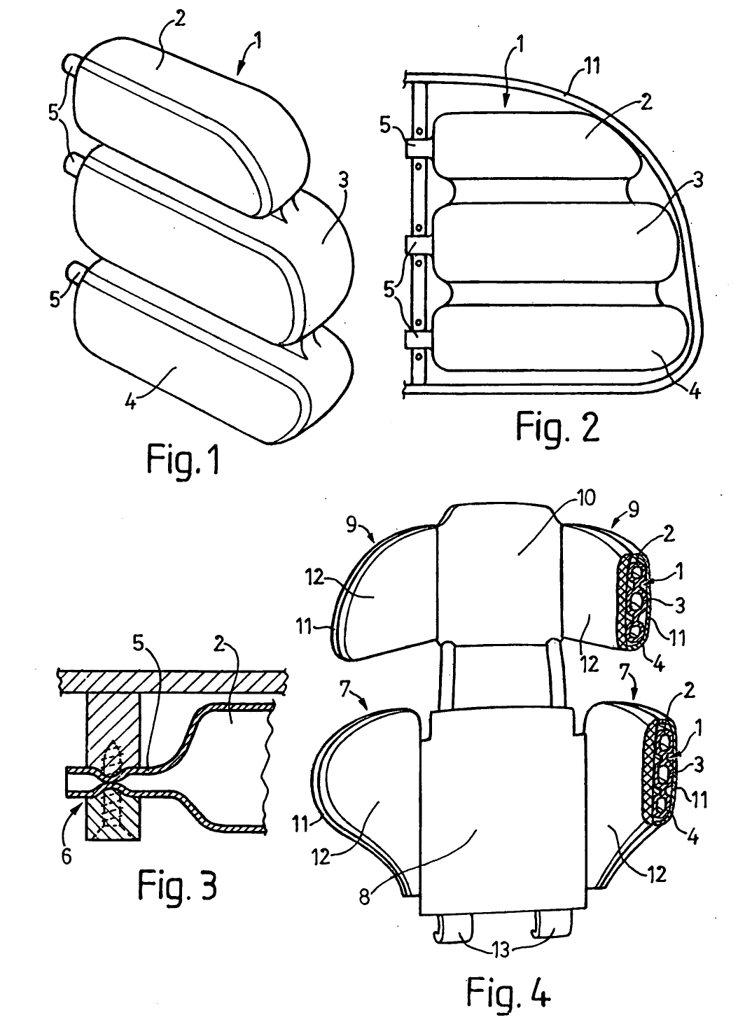

### DETAILED DESCRIPTION

According to the drawings the safety device being the object of the invention is characterized by being made up by a chamber (1) of plastics material with flexible walls and filled with air, said chamber preferentially being subdivided into several separate departments (2, 3 and 4) each having a nipple (5) comprising valve means (6) being such as to prevent the accidental outflow of the air under low pressures and to facilitate its progressive outflow when the departments (2, 3 and 4) are highly pressed.

The chamber (1) and the valve means (6) are arranged in the inside of the complementary side members (7) of the backrest (8) of the seat and of the complementary side members (9) of the headrest (10) of said backrest, in the empty space being formed between the rigid outer shell (11) and the deformable front plate (12) being generally made of “porex”, these latter shell and plate making up said complementary side members.

Numeral (13) denotes the connecting links for removably and articulately fitting the backrest (8) to the seat (not shown).

In the case of a hard collision the head and sides of the child will press the air chambers (1) being installed in the complementary side members (9) and (7) of the backrest and its headrest through the deformation of the plates (12) and will thus facilitate the progressive outflow of the air of the departments (2, 3 and 4) thus deadening the effects of the collision.

1-5. (canceled)

6. Collision safety device for infant seats formed by a chamber having flexible walls filled with air, the device comprising nipples facilitating the progressive outflow of the air when the chamber is highly pressed, wherein the chamber is subdivided into a plurality of compartments, wherein each compartment has one of said nipples for the outflow of the air, each of said nipples having a valve to prevent accidental outflow under low pressures of the air occupying the chamber and to open when receiving a high pressure to facilitate the outflow of the air.

7. Collision safety device for infant seats, as per claim 1, wherein the chamber and the valve means are arranged in the inside of complementary side members of a backrest of the infant seat and in complementary side members of a headrest of said backrest.

8. Collision safety device for infant seats, as per claim 6, wherein the chamber is installed in an empty space being formed between a rigid back shell and a deformable front plate, the shell and the plate comprising complementary side members.

9. Collision safety device for infant seats, as per claim 7, wherein the chamber is installed in an empty space formed between a rigid back shell and a deformable front plate, the shell and the plate comprising said complementary side members.
